(19) United States
(12) Patent Application Publication
(10) Pub. No.: US 2026/0357848 A1
(43) Pub. Date: Nov. 12, 2026

(54) SELF-LOCKING RETAINING HOOK

(71) Applicant: TECHNICAL AIRBORNE COMPONENTS INDUSTRIES- TAC, Herstal (BE)

(72) Inventor: Mathieu Chenoux, Arlon (BE)

(73) Assignee: TECHNICAL AIRBORNE COMPONENTS INDUSTRIES- TAC, Herstal (BE)

(21) Appl. No.: 19/127,880

(22) PCT Filed: Nov. 1, 2023
(86) PCT No.: PCT/EP2023/080458

§ 371 Date: May 7, 2025

(30) Foreign Application Priority Data
Nov. 10, 2022 (BE) BE2022/5912

(51) Int. Cl. F16B 45/04

(52) U.S. Cl. CPC F16B 45/049; F16B 45/051

(57) ABSTRACT

A retaining hook (2) with a mechanism for locking an attachment pin (5), this retaining hook (2) being installed on a tube (4a) and includes: a cylindrical body (2a) of straight section (S) in connection with the tube (4a) and a base (2f) from which extends a latch (2g) defining an opening (2h); a locking slide (3) translating along the cylindrical body (2a); and a compression spring (1a) between the locking slide (3) and the tube (4a). The base (2f) and the latch (2g) are contained inside a cylindrical volume of the same straight section (S) as an extension of the cylindrical body (2a), the latter having at least one oblong guide slot (2d). The locking slide (3) has at least one positioning hole (3a) and a blocking pin (3b) which partially obstructs the opening (2h) of the latch (2g) of the hook (2).

### TECHNICAL FIELD

The invention relates to a retaining hook arranged for example at the end of a connecting rod, this hook being equipped with an automatic locking system. Such a hook is used in particular as a locking part in sash opening holding mechanisms, in order to ensure that the sash remains in the open position after hanging.

In the aeronautical field in particular, access panels and hatches are moving parts of the external structure of an aircraft that allow access to elements of the internal structure when opened for inspection and/or maintenance operations. To carry out these operations, these panels and hatches are attached to connecting rods after they have been opened, this attachment making it possible to maintain the opening and prevent an unexpected closing of the panels or hatch. When the panels and hatches are closed, the hook is also used to hold the connecting rod hooked to the panel or hatch frame.

This hook can also be used to lock a closed panel in its frame. Such hooks can be used in any other field that uses hooks with manual release such as automotive, naval and construction in particular.

### PRIOR ART

Generally speaking, a hook is a tool for hanging and/or holding an object that is engaged in this hook. A simple hook classically has an anchor—performing the function of a hook—and a straight body. Made of a rigid material that is not very deformable, the simple hook can only perform its function if the attached object is stressed in tension in the curvature of the head.

A single hook can also be used to lock a moving element in a chosen position. For example, a door may have a hook with a straight body attached by a ball joint close to an edge of the door, which is long enough for the hook anchor to protrude from the door. When this door is closed in its frame, the hook anchor can be engaged in a ring or attachment pin attached to the door frame. The connection between the hook and the ring secures the door to its frame, thus locking the door in the closed position. This mode of locking is limited by the quality of the connection between the hook and the ring. This is because the simple insertion of the hook into the ring implies an equally simple removal of the hook.

To secure the hook, a locking means is added to this hook to lock the hooked piece.

Two approaches are commonly used to achieve this means of locking:
either the hook is closed; or
the hook is blocked.

A closure of the hook anchor results in a carabiner-type solution in which the nozzle creates a closed loop with an opening mechanism. However, a carabiner is an independent hooking device that does not fit at the end of the connecting rod. Another solution for closing a hook is the addition of an extendable type mechanism on the hook that allows the hook anchor to be closed. Such a mechanism increases the bulk around the hook to house this mechanism, which can hinder and weaken the grip. In addition, the installation and actuation of this extendable mechanism does not allow for a quick locking of the hook.

The other approach is to lock the hook into the structure that is hooked. This type of hook locking typically uses a mechanism installed on the hooked structure, this mechanism surrounds the hook and immobilizes it. However, this solution has the disadvantage of using an additional mechanism that increases the footprint, which needs to be installed and implemented.

The hook can also be closed by a rod attached to a ram sliding along the body of the hook. A spring positioned between the hook body and the slide holds the slide and the rod in such a position that the hook is closed. However, this assembly is generally definitive with crimping of the hook closing elements and made from the bottom of the hook body. This hook closing mechanism therefore does not allow for easy assembly or quick maintenance of the hook.

### DISCLOSURE OF THE INVENTION

In order to remedy the disadvantages of the prior art described above, the main objective of the invention is to improve the locking of a hook.

To do this, the invention provides for a locking mechanism that is installed at the base of the hook anchor and slides along the straight body of the hook. Advantageously, this mechanism locks automatically, thus allowing a quick locking, while freeing itself from the operation of manipulating the mechanism which extends the installation and secure placement of the hook. In addition, the mechanism is unlocked without the intervention of any particular tools.

More precisely, the present invention relates to a retaining hook automatically locking an attachment axis, said hook being mounted on a tube and comprising:
a cylindrical body of straight section, having two ends connecting respectively with the tube and a base from which extends an anchor defining an opening;
a locking slide in translation along the cylindrical body, and
a means of return between the locking ram and the tube.

In this holding hook, the base and the anchor are built in in a cylindrical volume of the same straight section as an extension of the cylindrical body, the latter comprising a bore for inserting the tube, a bore bottom and at least one oblong guide slot along the body. In addition, the locking ram has at least one positioning hole and a blocking pin that partially obstructs the opening of the hook spout.

Advantageously, the shape of the hook anchor in the extension of the cylindrical body reduces the size of the hook and allows the ram to be inserted through the spout. This makes the installation of the locking ram quick and easy thanks to the accessibility of the hook.

Also advantageously, the locking is carried out automatically when the attachment pin is attached. Indeed, when the hook comes in the vicinity of the attachment pin to hook it, the attachment pin makes contact with the blocking pin of the locking ram which partially obstructs the opening of the hook anchor so that the attachment pin cannot enter the opening of the hook head. Additional pressure of the attachment pin on the blocking pin causes the ram to be moved against the return medium, until there is enough of an opening for the attachment pin to enter the opening of the hook head and release the pressure on the blocking pin. The return means then returns the slider to its original position, the blocking pin again partially blocking the opening of the hook head and preventing the attachment pin from coming out of the hook, thus achieving automatic locking. The release is achieved by manually translating the slider to move the blocking pin and release the hook head opening.

According to preferred embodiments taken alone or in combination:
the return means is a compression spring, positioned at the bottom of the bore of the cylindrical body and resting against the tube;
the cylindrical body has two diametrically opposed oblong slots;
the two oblong slots extend on either side of the bottom of the bore;
the locking ram has two diametrically opposed positioning holes;
a holding pin is inserted into the two oblong guide slots and the two positioning holes, the pin being movable in the two oblong slots;
the blocking pin has a guide ramp;
the hook anchor has an end with a flat that orients the attachment pin towards the opening of the hook anchor;
the base of the hook has a sliding surface of the blocking pin and a stop surface of this blocking pin of the locking ram, and
the anchor of the hook has a continuous rear face with the cylindrical body.

Advantageously, the compression spring is positioned in the bore of the cylindrical body, providing protection for the return medium. The protected spring benefits from the hole drilled for the installation of the hook on the tube and optimizes the size of the hook.

Also advantageously, the blocking pin guide ramp allows the attachment axis to be guided during the hooking. When the attachment axis comes close to the free space left by the partial obstruction of the hook opening, this attachment axis comes into contact with the flat at the end of the hook anchor. The orientation of the attachment axis by this flat achieves the double function of orienting the attachment axis towards the opening of the hook head and initiating the automatic locking by directing the thrust of the attachment axis on the blocking pin in the optimal direction of travel of the ram.

The invention also relates to a method of automatically locking an attachment axis in the locking holding hook defined above and assembled according to the following steps:
positioning of the compression spring in the bore;
assembly of the cylindrical body with the tube;
insertion of the locking slide around the retaining hook;
alignment of the positioning holes of the locking ram with the oblong guide slots of the cylindrical body, and
insertion of the holding pin into the positioning holes and oblong guide slots.

The automatic locking of the attachment axis takes place, from a resting position in which the blocking pin of the ram partially obstructs the opening of the hook anchor, according to the following steps:
positioning of the attachment axis in the vicinity of the opening of the hook spout;
release of the opening of the hook anchor by pressing the attachment axis on the blocking pin and translation of the locking ram which compresses the compression spring;
Full insertion of the attachment axis into the hook spout, and
return of the compression spring that returns the locking ram to the resting position and automatically locks the attachment axis into the hook.

Advantageously, this automatic locking is quick to implement and can be carried out in a single movement and without any tools. In addition, the lock is secured by the blocking pin, which on the one hand locks the attachment axis in the hook and on the other hand cannot be operated by an attachment axis in the hook.

According to some preferred forms of implementation taken alone or in combination:
the step of releasing the opening of the hook anchor is carried out by moving the hook to the attachment axis or vice versa, and
during the step of pulling the ram during unlocking, the blocking pin slides on the sliding surface of the hook base.

The automatic locking is followed by a manual release which takes place according to the following steps:
release of the opening of the hook anchor by pulling the locking ram;
stop of the blocking pin on the base of the hook anchor and hold the locking ram in this position;
release of the attachment axis of the hook spout, and
release of the locking ram.

### DESCRIPTION OF THE FIGURES

Other features and advantages of the present invention will be apparent from the following reading of an example of an embodiment detailed without limiting its scope, with reference to the annexed figures which represent, respectively:

FIG. 1, a perspective exploded view of an example of a self-locking hook according to the invention;

FIG. 2, a perspective view of the bracket in FIG. 1;

FIG. 3, another perspective view of this bracket;

FIG. 4, a side view of this same hook installed on an aircraft sash connecting rod;

FIG. 5, a cross-sectional view of the said hook;

FIG. 6, a view according to another cross-section of the said hook;

FIG. 7, a side view of the locked hook, and

FIG. 8, a side view of the said unlocked hook.

### DETAILED DESCRIPTION

On the figures, identical reference signs refer to the same element as well as to the corresponding passages of the description.

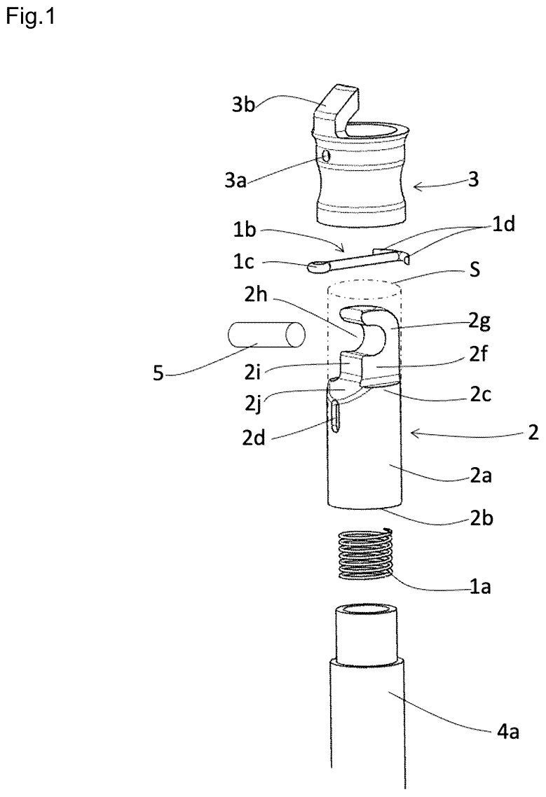

FIG. 1 shows an exploded and perspective view of the locking retaining hook 2, which allows for automatic locking and manual release of the attachment axis 5 of an aircraft nacelle cowl (not shown) in the example. This hook 2 is fitted to a tube 4a and comprises:
a cylindrical body 2a with a straight section S, circular in the example, this body 2a having two ends 2b, 2c, respectively connected to tube 4a, and a base 2f from which extends a nozzle 2g defining an opening 2h;
a locking slide 3 in translation along the cylindrical body 2a;
a compression spring 1a between the slide 3 and the tube 4a, and
a holding pin 1b.

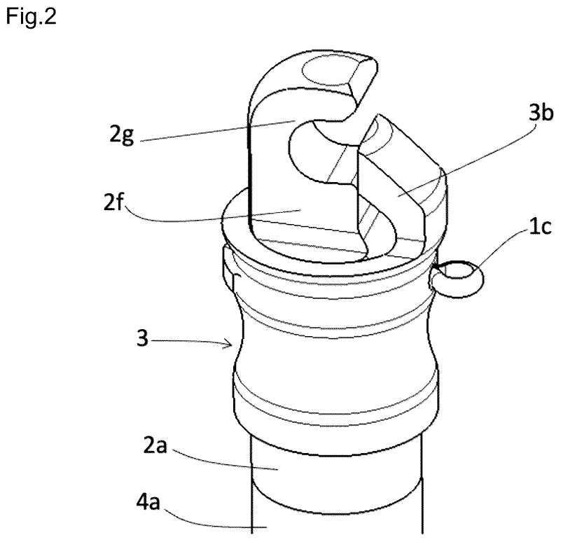

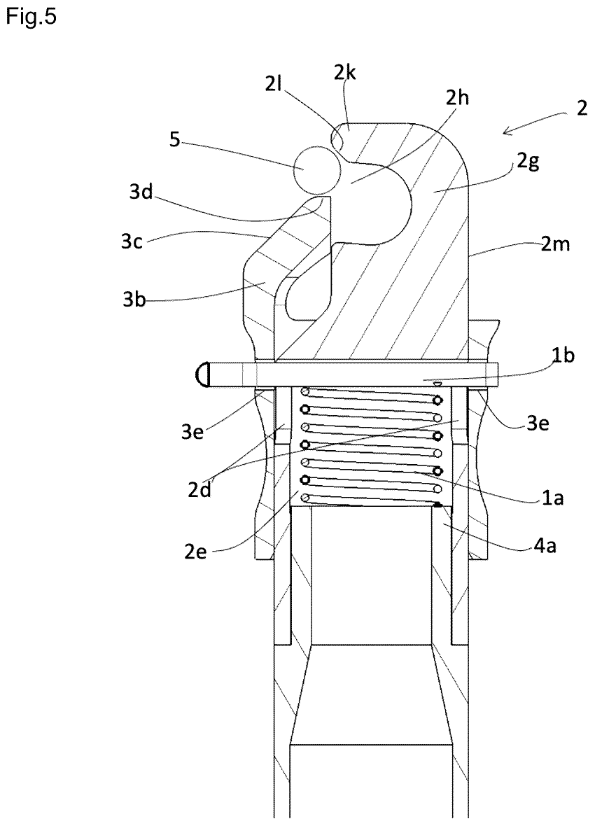

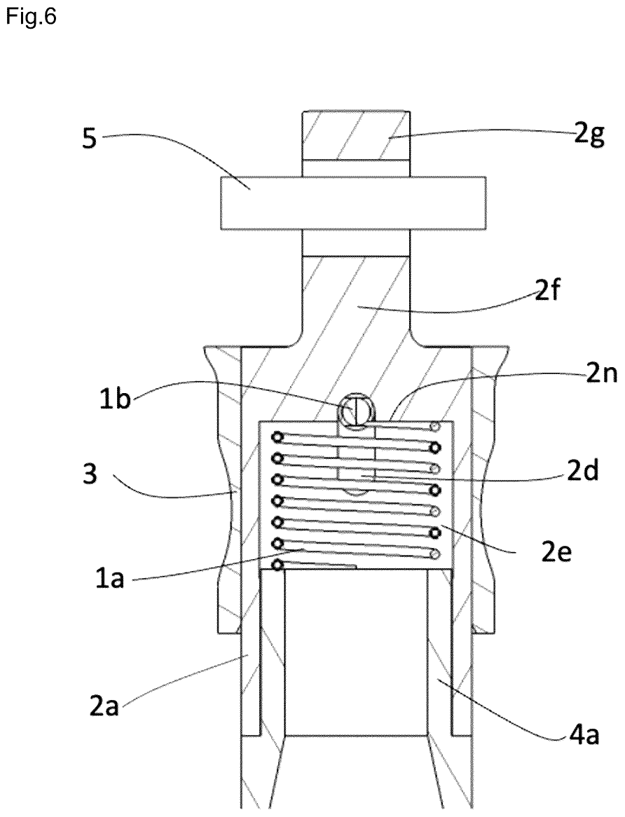

In this retaining hook 2, the base 2f and the anchor 2g are included in a cylindrical volume of the same straight section S circular, as an extension of the cylindrical body 2a. Body 2a has a bore 2e (shown in FIG. 5) for inserting tube 4a, a bottom 2n (shown in FIG. 6) for boring and two oblong 2d guide slots along the cylindrical body 2a, these two oblong 2d slots being diametrically opposed. In addition, the locking ram 3 has two diametrically opposed positioning holes 3a and a blocking pin 3b which partially obstructs (cf. the perspective view of the hook in FIG. 2) the opening 2h of the anchor 2g of the hook 2. The base 2f of the hook also has a sliding surface 2i of the blocking pin 3b and a stop surface 2j of this blocking pin 3b of the locking ram 3.

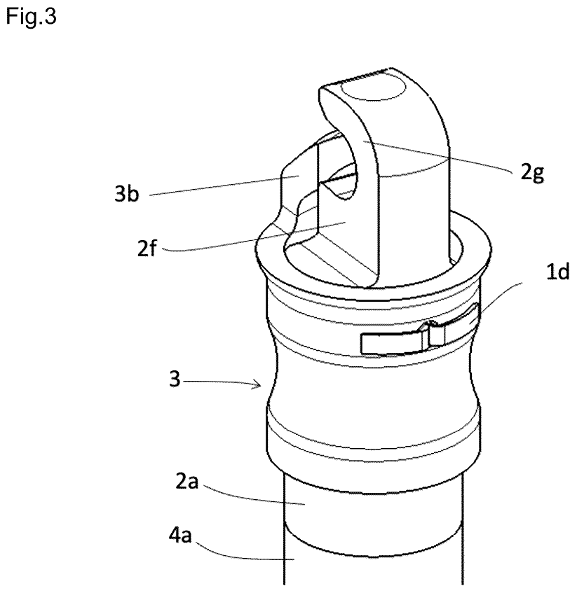

In addition, the holding pin 1b has a head 1c and fins 1d at its ends. The holding pin 1b is inserted by the fins 1d into the ram 3 positioning holes 3a and the oblong guide slots 2d. Since head 1c is larger than the positioning holes 3a, head 1c of pin 1b does not pass through ram 3. The fins 1d are then folded and rest on the ram 3 to prevent the extraction of the pin 1b. Pin 1b therefore holds hook 2 and the locking mechanism together as shown in the perspective views in FIG. 2 and FIG. 3. Alternatively, any type of pin to hold the slider can be used, especially with a ball in place of the head, fins at each end of the pin, or mechanical and/or magnetic locking mechanisms.

The assembly of hook 2 and the locking mechanism is shown in perspective and at two different angles in FIG. 2 and FIG. 3. The installation of the locking mechanism takes place in the following steps:
positioning of the compression spring 1a in the bore;
assembly of the cylindrical body 2a with the tube4a;
Inserting the locking slider 3 around the retaining hook 2;
Aligning the positioning holes 3a of the locking ram 3 with the oblong guide slots 2d of the cylindrical body 2a, and
Inserting the pin 1b into the positioning holes 3a and the oblong guide slots 2d.

Attaching the cylindrical body 2a to the tube 4a can be achieved by screwing, crimping, interlocking, welding or any other means of fixing. In addition, the alignment of the guide slots 2d of the cylindrical body 2a with the positioning holes 3a of the locking ram 3 allows the blocking pin 3b to be positioned in front of the opening 2h of the hook 2. In this example of an embodiment, the slots, holes, blocking pin, and hook opening are aligned. However, any other combination of alignments resulting in an alignment of the slots with the holes and an alignment of the blocking pin with the hook opening in a different direction from the alignment of the slots with the holes may be implemented.

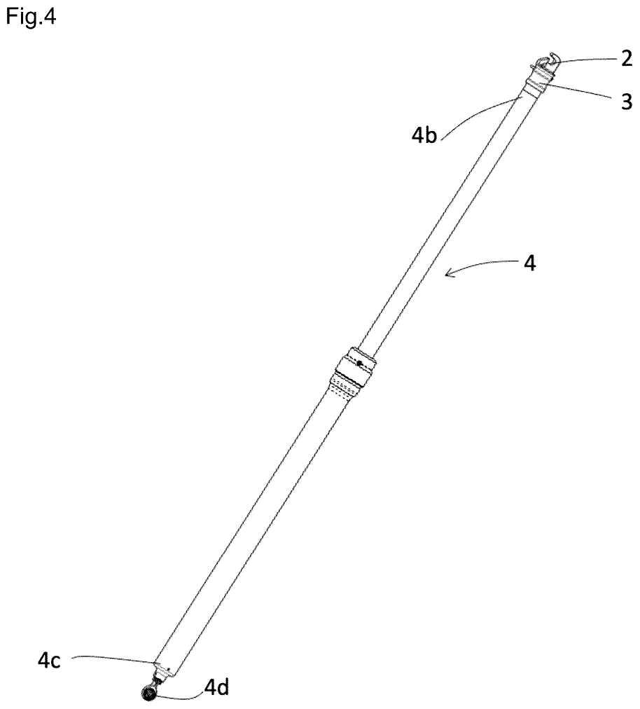

FIG. 4 shows a hook 2 according to the present invention which is installed at the end 4b of a telescopic connecting rod 4. This connecting rod 4 is deployed to keep open for example an aircraft nacelle cowl, this connecting rod 4 being linked by a pivot link 4d at its other end 4c. This pivot link 4d allows the connecting rod 4 to be either retracted and shortened, or extended in extension. When connecting rod 4 is extended, hook 2 can hold a cowl open, for example, this cowl having an attachment axis 5 (see the cross-sectional view in FIG. 5) adapted and positioned to engage with hook 2. In this example of application, the retaining hook, the slider and the tube are made of metal material. Depending on the masses and conditions of use, these elements can also be made of plastic and/or composite materials.

In another example of use, the hook is positioned in a door frame and the door has the appropriate attachment axis positioned to engage with the hook. When closing the door, the attachment axis engages the hook which locks and keeps the door closed.

The arrangement of the locking mechanism is detailed in the section view in FIG. 5 in the locked configuration. The compression spring 1a is then positioned in the bottom 2n of the bore 2e of the cylindrical body 2a and resting against the tube 4a.

In detail: the blocking pin 3b has a guide ramp 3c extending from the edge of ram 3 towards the opening 2h of hook 2, this guide ramp 3c ending in a thrust plate 3d perpendicular to the direction of travel of ram 3. In addition, the anchor 2g of hook 2 has an end 2k with a flat 2l that orients the attachment pin 5 towards the inside of the 2h opening of hook 2. In addition, the anchor 2g of hook 2 has a back face 2m that is continuous with the external surface of the cylindrical body 2a.

The attachment axis 5 is then positioned at the end2k, the anchor 2g, the hook 2 and the 3d thrust plate of the blocking pin 3b. Ram 3 and in particular the blocking pin 3b are sized so that, in the locked configuration, the free space between the end 2k of the anchor 2g and the thrust plate 3d of the blocking pin 3b is less than the diameter of the attachment axis 5. Thus, in this locked configuration, the attachment axis 5 can neither enter nor leave the anchor 2g of hook 2.

By soliciting the attachment axis 5 in the direction of the hook anchor, the attachment axis 5 rests on the flat 2l at the end 2k of the anchor2g. This flat 2l is oriented in such a way as to project the attachment pin 5 in the direction of travel of the ram 3 to cause its displacement in reaction, the attachment pin 5 being in contact with the thrust plate 3d at the end of the guide ramp 3c of the blocking pin3d. This thrust plate 3d is oriented in such a way as to optimize the effect of the attachment axis 5 on the blocking pin 3b and push the ram 3 to release the opening 2h of hook 2 automatically.

FIG. 6 shows another cross-section of the locking mechanism that illustrates the position of the oblong guide slots 2d relative to the bore 2e of the cylindrical body 2a of hook 2. The compression spring 1a rests against the bottom 2n of the bore 2e and, to facilitate the insertion of pin 1b into the cylindrical body 2a of hook 2, this pin 1b is inserted at the end of the compression spring 1a. To do this, the oblong guide slots 2d extend on either side of the bottom 2n of the bore 2e, the insertion area of the pin 1b in the oblong slots 2d being of a dimension equivalent to the thickness of the pin 1b.

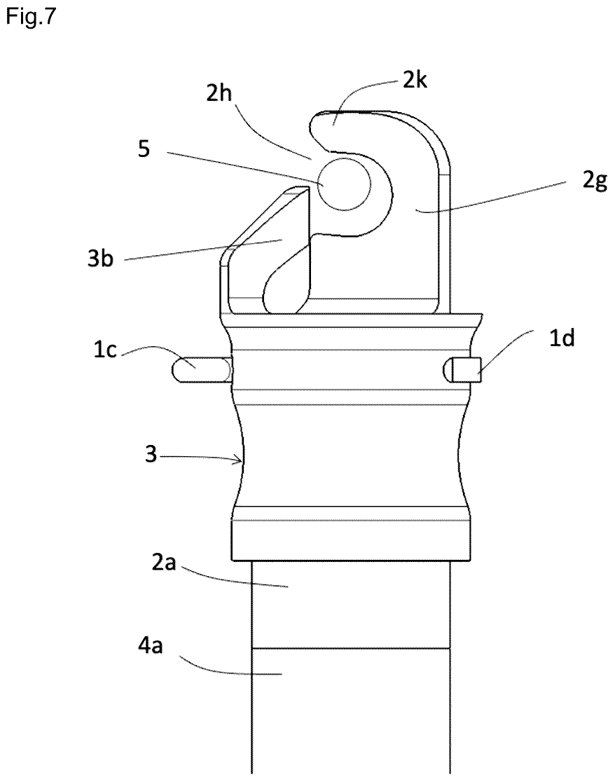

The end state of the retaining hook 2 is shown in FIG. 7. A resting position of the locking mechanism is defined when the spring holds the ram in the locking configuration and in which the blocking pin 3b of the ram 3 partially obstructs the opening 2h of the anchor 2g of hook 2, as shown in the side view in FIG. 7. The automatic locking takes place from the resting position according to the following steps:
positioning of the attachment axis 5 in the vicinity of the opening 2h of the anchor 2g of hook 2;
release of the opening 2h of the anchor 2g of hook 2 by pressing the attachment pin 5 on the blocking pin 3b and translation of the locking ram 3 which compresses the compression spring 1a;
complete insertion of the attachment axis 5 into the spout 2g of hook 2, and return of the compression spring 1a which returns the locking slide 3 to the resting position and then automatically locks the attachment axis 5 in the hook 2. The translation of the ram 3 is possible by moving the movable pin 1b in the oblong slots 2d.

Alternatively, the blocking pin 2d can totally obstruct the opening 2h of the hook anchor 2g.

The step of clearing the opening 2h of the anchor 2g is generally carried out by moving the retaining hook 2 to the attachment axis 5 or vice versa. The configuration of the blocking pin is such that the attachment axis 5 cannot exert any action on the blocking pin 3b to move the ram 3 when it is in the anchor 2g of the hook 2. At the end of this locking, the attachment axis 5 is hooked up and the locking mechanism is back in the rest position. This locking is said to be automatic because it occurs spontaneously when the attachment axis is pushed into the opening of the hook.

Manual unlocking is carried out in the following steps;
release of the opening 2h of the anchor 2g of hook 2 by pulling the locking ram 3;
stop the blocking pin 3b on the base 2f of the anchor 2g of hook 2 and hold the locking ram 3 in this position;
release of the attachment axis 5 of the anchor 2g of hook 2, and
release of the locking ram 3.

During the pull stage of the ram 3 when unlocking, the blocking pin 3b slides over the sliding surface 2i of the base 2f of hook 2 and the pin 1b moves into the oblong slots 2d. The movement of the locking ram 3 is limited by the stop surface 2j of the hook base 2f. Alternatively or in combination, this displacement of the locking ram may be limited by the length of the oblong slots 2d and the stop of the pin 1b at the end of these oblong slots 2d, by the compression limit of the spring 1a or by any other amplitude limiting means.

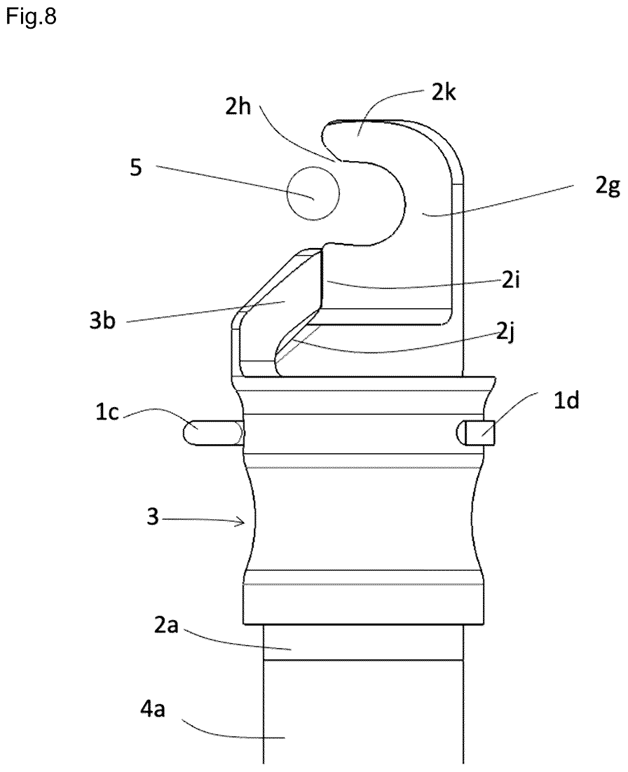

The configuration of hook 2 at the end of this step is shown in FIG. 8. In this figure, it appears that the locking ram 3 completely releases the opening 2h of hook 2 and that the attachment pin 5 is therefore free to exit this opening 2h of hook 2 by moving hook 2 to the attachment pin 5 or vice versa.

The invention is not limited to the examples described and represented. It is possible to envisage any type of straight section of the cylindrical body, in particular polygonal or “U” shaped. In addition, any means of reminder with shape memory or not (elastic blade, tension spring, etc.) can also be used. The manual release of the hook can also be operated by an automated and/or controlled mechanism.

1. A tube (4a) with a retaining hook (2) for automatic locking of an attachment axis (5), said retaining hook (2) being installed on a tube (4a) and comprising:
a cylindrical body (2a) of straight cross-section(S) and having two ends (2b, 2c) in connection with the tube (4a) respectively and a base (2f) from which extends an anchor (2g) defining an opening (2h);
a locking ram (3) in translation along the cylindrical body (2a), and
a returning device to return between the locking ram (3) and the tube (4a);
wherein the base (2f) and the anchor (2g) are included in a cylindrical volume of the same straight cross-section (S) as an extension of the cylindrical body (2a), the latter having a bore (2e) for inserting the tube (4a), a bottom (2n) of the bore and at least one oblong slot (2d) for guiding along the cylindrical body (2a) and in that the locking slide (3) has at least one positioning hole (3a) and a blocking pin (3b) which partially obstructs the opening (2h) of the hook anchor (2g).

2. The tube (4a) according to claim 1, wherein the return device is a compression spring (1a) positioned in the bottom (2n) of the bore (2e) for inserting the cylindrical body (2a) and resting against the tube (4a).

3. The tube (4a) according to claim 1, wherein the cylindrical body (2a) has two diametrically opposed oblong slots (2d) extending on either side of the bottom (2n) of the bore (2nd).

4. The tube (4a) according to claim 1, wherein the locking ram (3) has two diametrically opposed positioning holes (3a).

5. The tube (4a) according to claim 4, wherein the retaining (2) has a holding pin (1b) inserted into the two oblong slots (2d) and the two locating holes (3a), the pin (1b) being movable in the two oblong slots (2d).

6. The tube (4a) according to claim 1, wherein the blocking pin (3b) has a guide ramp.

7. The tube (4a) according to claim 1, wherein the anchor (2g) of the retaining hook (2) has an end (2k) having a flat (2l) of orientation of the attachment axis (5) towards the opening (2h) of the anchor (2g) of the retaining hook (2).

8. The tube (4a) according to claim 1, wherein the base (2f) of the retaining hook (2) comprises a sliding surface (2i) of the blocking pin (3b) and a stop surface (2j) of said blocking pin (3b) of the locking ram (3).

9. The tube (4a) according to claim 1, wherein the anchor (2g) of the retaining hook (2) has a continuous rear face (2m) with the cylindrical body (2a).

10. A method for automatically locking an attachment axis (5) in the locking retaining hook (2) according to claim 5 and the assembly of which is carried out in the following steps:
positioning of the compression spring (1a) in the bore (2e);
connection of the cylindrical body (2a) with the tube (4a);
insertion of the locking slide (3) around the retaining hook (2);
alignment of the positioning holes (3a) of the locking ram (3) with the oblong guide slots (2d) of the cylindrical body (2a), and
insertion of the pin (1b) into the positioning holes (3a) and the oblong guide slots (2d);
wherein the automatic locking of the attachment axis (5) takes place from a resting position in which the blocking pin (3b) of the ram (3) partially obstructs the opening (2h) of the anchor (2g) of the retaining hook (2) according to the following steps
positioning of the attachment axis (5) in the vicinity of the opening (2h) of the anchor (2g) of the retaining hook (2);
clearing of the opening (2h) of the anchor (2g) of the retaining hook (2) by pressing the attachment axis (5) on the blocking pin (3b) and translation of the locking ram (3) which compresses the compression spring (1a);
complete insertion of the attachment axis (5) into the anchor (2g) of the retaining hook (2), and
return of the compression spring (1a) which returns the locking ram (3) to the resting position and which automatically locks the attachment axis (5) in the retaining hook (2).

11. The method of claim 10, wherein the step of releasing the opening of the anchor (2g) of the retaining hook (2) is carried out by moving the retaining hook (2) to the attachment axis (5) or vice versa.

12. The method according to claim 10, wherein during the pull step of the slider (3) during manual release, the blocking pin (3b) slides over the sliding surface (2i) of the base (2f) of the retaining hook (2).

13. The method according to claim 10, wherein the automatic locking is followed by a manual release which is carried out in the following steps:
releasing the opening (2h) of the anchor (2g) of the retaining hook (2) by pulling the locking ram (3)
stopping the blocking pin (3b) on the base (2f) of the anchor (2g) of the hook and holding the locking ram (3) in this position;
release of the attachment axis (5), the spout (2g) of the retaining hook (2), and release of the locking slide (3).
